(19) United States
(12) Patent Application Publication
(10) Pub. No.: US 2025/0153376 A1
(43) Pub. Date: May 15, 2025

(54) HEAT SENSOR ACTIVATED HAIR STYLING DEVICE

(71) Applicant: Mario Houston, Stockbridge, GA (US)

(72) Inventor: Mario Houston, Stockbridge, GA (US)

(21) Appl. No.: 18/509,846

(22) Filed: Nov. 15, 2023

(51) Int. Cl. B26B 19/38; B26B 19/06; G01K 1/14

(52) U.S. Cl. CPC B26B 19/388; B26B 19/06; G01K 1/14; G01K 2215/00

(57) ABSTRACT

A hair styling device for activating to treat hair of an individual when the device senses body heat of the individual includes a housing and a hair treatment mechanism mounted to the housing. A processor is operatively coupled to the hair treatment mechanism, the processor is mounted in the housing. A heat sensor is operatively coupled to the processor and is mounted to the housing adjacent to the hair treatment mechanism. The heat sensor faces away from the housing and is oriented such that the heat sensor is configured to face the individual when the hair treatment mechanism is in use on the hair of the individual. The processor is configured to activate the hair treatment mechanism when the heat sensor detects heat indicative of the heat sensor lying adjacent to the individual.

### BACKGROUND OF THE INVENTION

### (1) Field of the Invention

The disclosure relates to hair treatment devices and more particularly pertains to a new hair treatment device for activating to treat hair of an individual when the device senses body heat of the individual.

### (2) Description of Related Art Including Information Disclosed Under 37 CFR 1.97 and 1.98

The prior art discloses myriad hair treatment devices but fails to describe such a device which activates when the hair treatment device senses body heat of the individual. Such a device is advantageous over the prior art because it conserves electrical power by limiting electricity usage when the device is not being used to treat hair.

### BRIEF SUMMARY OF THE INVENTION

An embodiment of the disclosure meets the needs presented above by generally comprising a housing and a hair treatment mechanism mounted to the housing. A processor is operatively coupled to the hair treatment mechanism, the processor is mounted in the housing. A heat sensor is operatively coupled to the processor and is mounted to the housing adjacent to the hair treatment mechanism. The heat sensor faces away from the housing and is oriented such that the heat sensor is configured to face an individual when the hair treatment mechanism is in use on hair of the individual. The processor is configured to activate the hair treatment mechanism when the heat sensor detects heat indicative of the heat sensor lying adjacent to the individual.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a hair styling device according to an embodiment of the disclosure.

FIG. 2 is a rear perspective view of an embodiment of the disclosure.

FIG. 3 is a first side view of an embodiment of the disclosure.

FIG. 4 is a second side view of an embodiment of the disclosure.

FIG. 5 is a block diagram of an embodiment of the disclosure.

FIG. 6 is an in-use view of an embodiment of the disclosure.

### DETAILED DESCRIPTION OF THE INVENTION

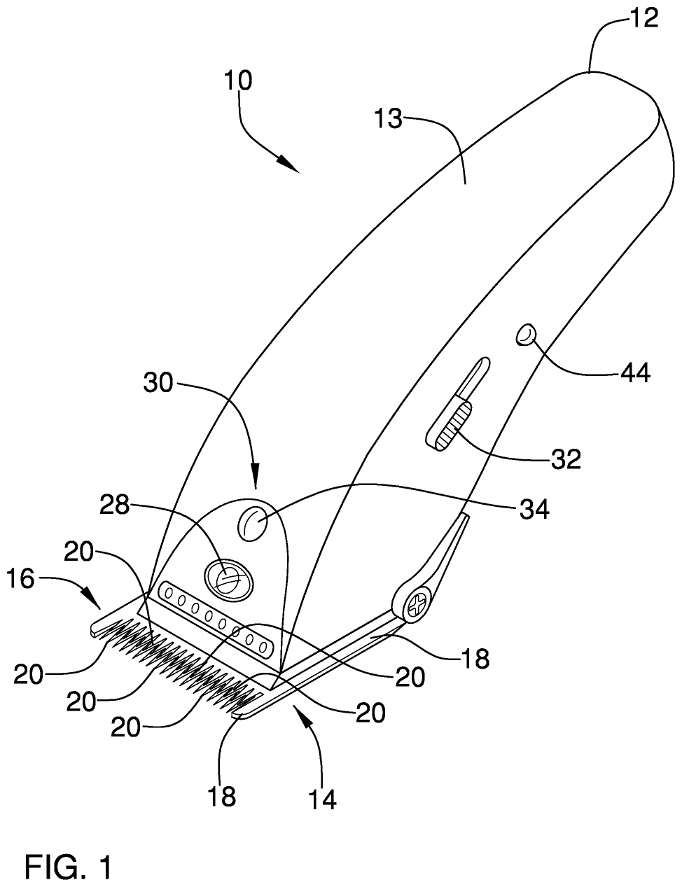

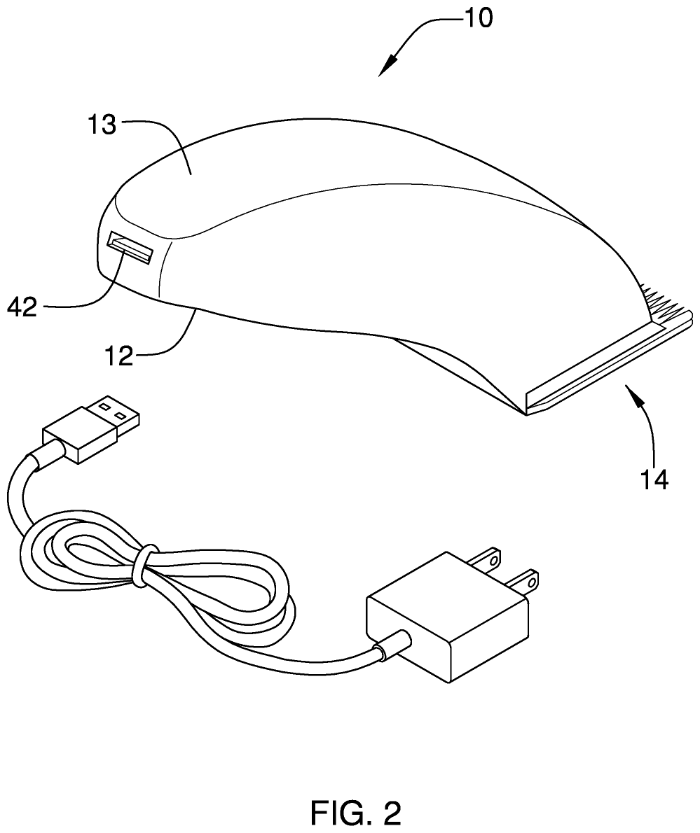

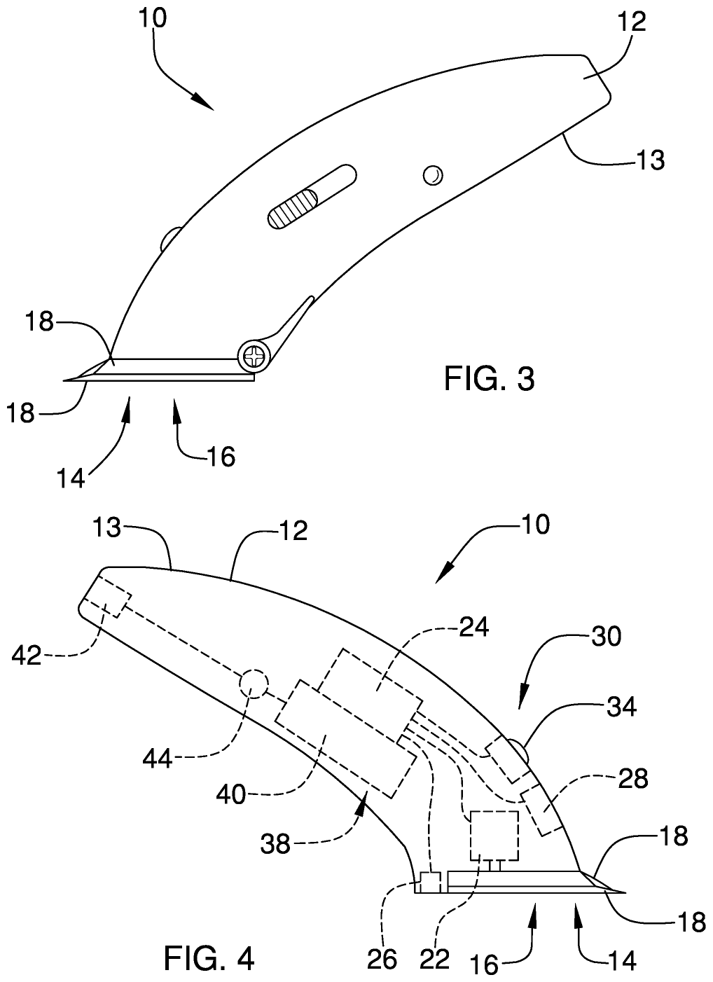

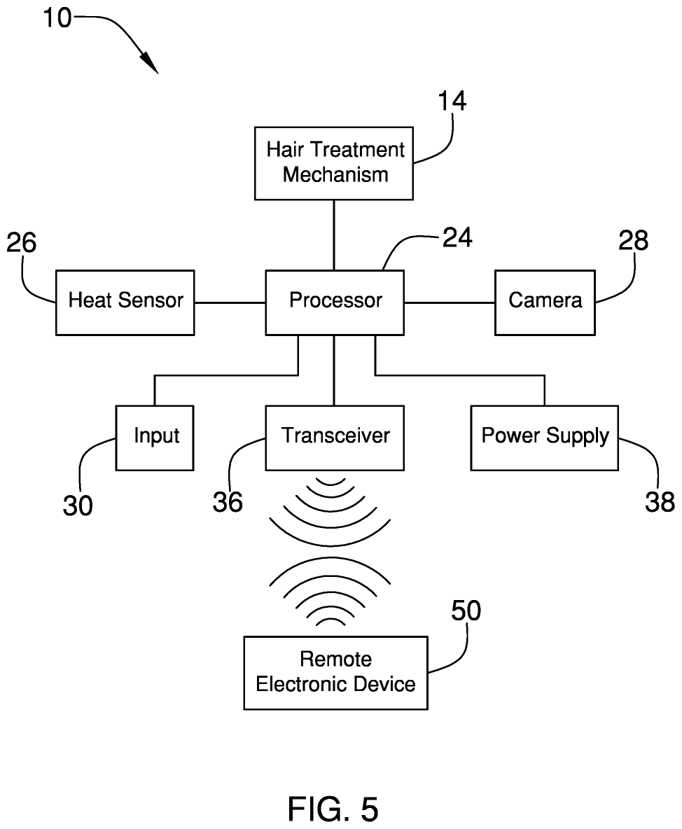

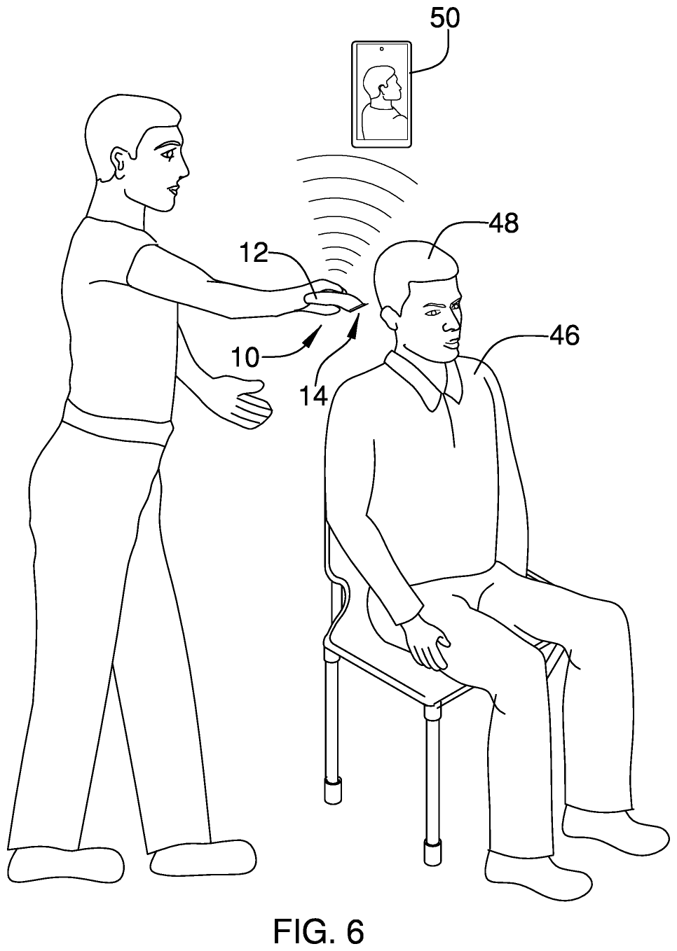

With reference now to the drawings, and in particular to FIGS. 1 through 6 thereof, a new hair treatment device embodying the principles and concepts of an embodiment of the disclosure and generally designated by the reference numeral 10 will be described.

As best illustrated in FIGS. 1 through 6, the hair styling device 10 generally comprises a housing 12 and a hair treatment mechanism 14 mounted to the housing 12. The hair treatment mechanism 14 comprises a trimmer 16 which is positioned on an exterior 13 of the housing 12. The trimmer 16 comprises a pair of blades 18 and a motor 22. Each blade 18 of the pair of blades 18 has a plurality of cutting teeth 20 facing a same direction. The blades 18 are movable with respect to each other to cause a shearing motion between the plurality of cutting teeth 20 of one blade 18 of the pair of blades 18 and the plurality of cutting teeth 20 of another blade 18 of the pair of blades 18. The motor 22 is positioned in the housing 12 and is operatively coupled to the one blade 18 of the pair of blades 18. The hair treatment mechanism 14 may also comprise a flat iron, a blow dryer, a hair clipper, or the like.

A processor 24 is operatively coupled to the hair treatment mechanism 14 and is mounted in the housing 12. A heat sensor 26 is operatively coupled to the processor 24 and is mounted to the housing 12 adjacent to the hair treatment mechanism 14 opposite the plurality of cutting teeth 20 of the pair of blades 18. The heat sensor 26 faces away from the housing 12 and is oriented such that the heat sensor 26 is configured to face an individual 46 when the hair treatment mechanism 14 is in use on hair 48 of the individual 46. The processor 24 is configured to activate the hair treatment mechanism 14 when the heat sensor 26 detects heat indicative of the heat sensor 26 lying adjacent to the individual 46 and to deactivate the hair treatment mechanism 14 when the heat sensor 26 does not detect heat indicative of the heat sensor 26 lying adjacent to the individual 46.

A camera 28 is operatively coupled to the processor 24. The camera 28 is mounted to the housing 12 adjacent to the hair treatment mechanism 14 and adjacent to the plurality of cutting teeth 20 of the pair of blades 18. The camera 28 is configured to face the individual 46 when the hair treatment mechanism 14 is in use on the hair 48 of the individual 46. An input 30 is operatively coupled to the processor 24 and is mounted on the exterior 13 of the housing 12. The input 30 comprises a sensor control 32 for alternately activating and deactivating the heat sensor 26 and a camera control 34 for alternately activating and deactivating the camera 28. A transceiver 36 is operatively coupled to the processor 24 wherein the processor 24 is configured to be in signal communication with a remote electronic device 50. The processor 24 is configured to selectively transmit images captured by the camera 28 via the transceiver 36 to the remote electronic device 50.

A power supply 38 is electrically coupled to the processor 24 and comprises a battery 40. A charging port 42 is electrically coupled to the battery 40 and is mounted on the exterior 13 of the housing 12. A charge indicator 44 is operatively coupled to the battery 40 and is configured to indicate when the battery 40 is charging.

In use, the processor 24 causes the hair treatment mechanism 14 to activate when the hair styling device 10 is positioned such that the heat sensor 26 detects the body heat of the individual 46. In such a position, the hair styling device 10 is used to treat the hair 48 of the individual 46 with the hair treatment mechanism 14. The camera 28 is selectively activated to record still or video images which are transmitted via the transceiver 36 to the remote electronic device 50, which may be a smart phone, a computer, a tablet, or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hair styling device comprising:
a housing;
a hair treatment mechanism mounted to the housing;
a processor being operatively coupled to the hair treatment mechanism, the processor being mounted in the housing; and
a heat sensor being operatively coupled to the processor, the heat sensor being mounted to the housing adjacent to the hair treatment mechanism, the heat sensor facing away from the housing, the heat sensor being oriented such that the heat sensor is configured to face an individual when the hair treatment mechanism is in use on hair of the individual, the processor being configured to activate the hair treatment mechanism when the heat sensor detects heat indicative of the heat sensor lying adjacent to the individual.

2. The device of claim 1, wherein the hair treatment mechanism comprises:
a trimmer positioned on an exterior of the housing, the trimmer comprising a pair of blades, each blade of the pair of blades having a plurality of cutting teeth facing a same direction, the pair of blades being movable with respect to each other to cause a shearing motion between the plurality of cutting teeth of one blade of the pair of blades and the plurality of cutting teeth of another blade of the pair of blades; and
a motor being positioned in the housing and being operatively coupled to the one blade of the pair of blades.

3. The device of claim 1, wherein the processor is configured to deactivate the hair treatment mechanism when the heat sensor does not detect heat indicative of the heat sensor lying adjacent to the individual.

4. The device of claim 1, further comprising a camera being operatively coupled to the processor, the camera being mounted to the housing adjacent to the hair treatment mechanism, the camera being configured to face the individual when the hair treatment mechanism is in use on the hair of the individual.

5. The device of claim 1, further comprising an input being operatively coupled to the processor, the input comprising a sensor control, the sensor control being actuatable to alternately activate and deactivate the heat sensor.

6. The device of claim 4, further comprising an input being operatively coupled to the processor, the input comprising:
a sensor control, the sensor control being actuatable to alternately activate and deactivate the heat sensor; and
a camera control, the camera control being actuatable to alternately activate and deactivate the camera.

7. The device of claim 4, further comprising a transceiver being operatively coupled to the processor wherein the processor is configured to be in signal communication with a remote electronic device, the processor being configured to transmit images captured by the camera via the transceiver to the remote electronic device.

8. The device of claim 1, further comprising a power supply being electrically coupled to the processor.

9. The device of claim 8, wherein the power supply comprises a battery.

10. The device of claim 9, further comprising a charging port being electrically coupled to the battery and being mounted on the exterior of the housing.

11. The device of claim 10, further comprising a charge indicator being operatively coupled to the battery, the charge indicator being configured to indicate when the battery is charging.

12. A hair styling device comprising:
a housing;
a hair treatment mechanism mounted to the housing, the hair treatment mechanism comprising:
a trimmer positioned on an exterior of the housing, the trimmer comprising a pair of blades, each blade of the pair of blades having a plurality of cutting teeth facing a same direction, the pair of blades being movable with respect to each other to cause a shearing motion between the plurality of cutting teeth of one blade of the pair of blades and the plurality of cutting teeth of another blade of the pair of blades; and
a motor being positioned in the housing and being operatively coupled to the one blade of the pair of blades;
a processor being operatively coupled to the hair treatment mechanism, the processor being mounted in the housing;
a heat sensor being operatively coupled to the processor, the heat sensor being mounted to the housing adjacent to the hair treatment mechanism, the heat sensor facing away from the housing, the heat sensor being oriented such that the heat sensor is configured to face an individual when the hair treatment mechanism is in use on hair of the individual, the processor being configured to activate the hair treatment mechanism when the heat sensor detects heat indicative of the heat sensor lying adjacent to the individual, the heat sensor being positioned opposite the plurality of cutting teeth of the pair of blades, the processor being configured to deactivate the hair treatment mechanism when the heat sensor does not detect heat indicative of the heat sensor lying adjacent to the individual;
a camera being operatively coupled to the processor, the camera being mounted to the housing adjacent to the hair treatment mechanism, the camera being positioned adjacent to the plurality of cutting teeth of the pair of blades, the camera being configured to face the individual when the hair treatment mechanism is in use on the hair of the individual;
an input being operatively coupled to the processor and being mounted on the exterior of the housing, the input comprising:
a sensor control, the sensor control being actuatable to alternately activate and deactivate the heat sensor; and
a camera control, the camera control being actuatable to alternately activate and deactivate the camera;
a transceiver being operatively coupled to the processor wherein the processor is configured to be in signal communication with a remote electronic device, the processor being configured to transmit images captured by the camera via the transceiver to the remote electronic device;
a power supply being electrically coupled to the processor, the power supply comprising a battery;
a charging port being electrically coupled to the battery and being mounted on the exterior of the housing; and
a charge indicator being operatively coupled to the battery, the charge indicator being configured to indicate when the battery is charging.
